(19) United States
(12) Patent Application Publication
(10) Pub. No.: US 2009/0030833 A1
(43) Pub. Date: Jan. 29, 2009

(54) HYBRIDIZED REVERSE AUCTION WITH DYNAMIC FORWARD BIDDINGS FOR REALTY-RELATED TRADING

(76) Inventor: Yiu-Ming Leung, Midlevels (CN)

Correspondence Address: WILLIAM D. HARE, 66 WITHERSPOON STREET, STE. 1, PMB 317, PRINCETON, NJ, 08542-9944, US

(21) Appl. No.: 12/179,558

(22) Filed: Jul. 24, 2008

Related U.S. Application Data
(60) Provisional application No. 60/951,759, filed on Jul. 25, 2007.

(51) Int. Cl. G06Q 30/00; G06Q 50/00

(52) U.S. Cl. 705/37

(57) ABSTRACT

The invention relates to computer-implemented systems and methods for creating a reverse auction on a realty related item. A buyer uses a computer-system programmed with an algorithm for creating the reverse auction and one or more sellers use a computer-system programmed with an algorithm to submit bid items. The set of procedures comprises that (1) the seller's bid item can individually undergo forward bidding by other buyers to form a forward auction on the item and (2) the series of forward biddings of one or more bid items continuously updates the bid information in the reverse auction.

### FIELD OF THE INVENTION

This invention relates to a new form of online auction. In particular, this invention relates to a brand new method and system, namely Hybridized Reverse Auction with Dynamic Forward Biddings, specifically embodied for real estate related trading.

### BACKGROUND

The current method and system for real estate transaction are largely performed by realty agent or broker, and the success relies heavily on their art and skills of negotiation. The negotiation process is not revealed to the public. Because the agent or broker pushes on prompt transaction on limited choices, the transaction is not optimized in terms of price, premise choices, premise qualities and timing, i.e. inefficient trading. Before the evolvement of Internet, the widely practiced Multiple Listing Service (MLS) in U.S., Canada and some other countries can help disseminate premise information and thus solicit more potential buyers. However, it does not help negotiate, make decision or accelerate the buying process anyhow. The use of the Internet is, up to now, confined mainly in enhancing the MLS in the way of providing a more efficient and convenient access to premise information only.

Online auction should be able to provide highly transparent market, bring in numerous market participants, increase market competition, render the transaction price closest to the fair market value and enable best suited item to requirements. However, even the most related online auction method and system ever published cannot induce many market participants for competition in real estate items. On the other hand, there are online reverse auction methods and systems for the general commodities or some specific products other than real estate, e.g. air ticket and financial products, which do not have specific embodiment for realty related trading. The new invention addresses the above problems by efficiently enhance market competition and provide specific embodiments for realty related item.

### DESCRIPTION OF RELATED ART

Besides the critical roles played by realty agent or broker and the MLS in the industry as mentioned above, some internet newbie try to provide “limited service”, e.g. supply potential buyers or sellers without providing negotiation service, or provide professional negotiation and process supervision without soliciting potential buyers and sellers. They charge less commission in contrast to the traditional, full service provided by MLS registered agents or brokers, e.g. Realtor. They use Internet no more than setting up an online company for attracting potential buyers and sellers. The process of negotiation and decision making are still the part of human art and skills.

On the other hand, “offline” auction has been traditionally used for real estate transaction. For example, there are face-to-face auctions (ascending bid ones) held from time to time at a public venue, say a hotel ballroom, for valuable premise or banks' collateral realty item. Since it does not involve online bidding, the number of buyers and sellers are limited.

For online auction, there have been various forms in the market or published in literature. To name a few, there is online English Auction (the famous one being the time-dependent auction at eBay.com), Dutch Auction, Vickrey Auction, Reverse auction (the famous one being the time-dependent reverse auction at Priceline.com), Double Auctions, Hybrid Auction, Combinatorial Auction, Double Dutch Auction, etc. Almost all of them are designed for general items including real estate, with only few of them for specific products such as financial products and air ticket. Up to now, the online auctions specifically for real estate items are all forward auctions in nature with differentiation on some features of the method. e.g. reserve price, or increment handling, etc.

In conclusion, there is no online reverse auction specifically for realty-related items up to this moment, not to mention the hybridized form of incorporating new concepts of dynamic forward biddings into reverse auction. On the other hand, the concurrence nature of synchronizing two forms of auctions, i.e. forward and reverse auction, so as to efficiently increase competition within a fixed timeframe is first-of-its-kind for realty-related items.

### SUMMARY OF THE INVENTION

It starts with a buyer creating a time-dependent reverse auction, and during the process of reverse auction, allows the sellers' bid items to undergo individually forward biddings made by other buyers. The individual forward biddings, which are numerous ascending bid auctions in nature, synchronize updated information and end at the same time as the reverse auction. The parent reverse auction and its associated forward biddings constitute a new form of online auction called “Hybridized Reverse Auction”. They involve highly transparent “price negotiation” process that can attract much more buyers, sellers and their proxies if any, to the online marketplace within the same time resources (i.e. the auction period). (FIG. 1)

If a buyer and a seller can confirm an item at a price, early exit of the reverse auction or forward bidding is allowed and they will probably request for immediate item investigation, e.g. site visit and face-to-face negotiation on other terms. This can expedite the matching. Moreover, as long as the sale and purchase of the item is not yet confirmed, sellers having similar items who can offer “lower than the lowest” price concluded after the reverse auction, or buyers who can offer “higher than the highest” price concluded after a forward bidding, can “jump the queue” and request to meet the counterpart if willing to pay surcharge. This can further increase the number of market participants.

All in all, the object of the new invention is to increase market competition by increasing market participants, i.e. buyer and seller, within the same time resource by means of hybridizing the reverse auction with a number of dynamic forward biddings so that better matches and pricing than a pure, single-directional reverse auction happen in most efficient way. It also expedites the buying and selling decision through dynamic listing of price movements. As a result, a highly efficient trading is enabled.

It is another object of the new invention to embody a new method and system for realty related trading. It breaks through the conventional information seeking and negotiation process of real estate transaction made by agent or broker. The premise information is ample and well-organized in the website, and the website also acts as a resource for providing large numbers of potential buyer or sellers. It can take up the role of agent/broker by providing general premise information and matching of buyer and seller on preferred price before site visit. The role of agent and broker has changed from information provider and buyer/seller solicitation to professional realty consultant on process supervision and service customization.

### BRIEF DESCRIPTION OF THE DRAWINGS

FIG. 1 The Concept of Hybridized Reverse Auction with Dynamic Forward Biddings. It is to point out that the listings are intercommunicating and updated information is synchronized on the listings.

FIG. 2 The System for Performing the Invention A main system, comprising a normal internet set-up, integrates with the private network of individual agent's or broker's office. It is to point out that the private network may not be integrated with the main system.

FIG. 3 The Flow Chart Showing the Method of the Invention. It shows the total logics for performing the method of invention.

FIG. 4 The Interface for User Registration and User Details Modification. Users include buyer (potential future premise owner, potential tenant), seller (the premise owner) and their proxies, e.g. estate agent or broker.

FIG. 5 The Interface for Reverse Auction Listing. Reverse auctions in different categories, e.g. the closing auctions, can be viewed at a glance.

FIG. 6 The Interface for Forward Bidding. Forward biddings are categorized and can be viewed at a glance.

FIG. 7 The Interface for Input of Premise Information. Some data are essential and mandatory for input, while the others are optional.

FIG. 8 Selection of Appropriate Reverse Auction for Bidding. Same interface as in FIG. 5. It shows the mean for sellers to bid by a simple click.

FIG. 9 The Interface for Creating and Modifying Bid. Buyer and Seller use this interface for creating and further modification of data, e.g. bid price.

FIG. 10 The Interface for Creating Time-Dependent Reverse Auction. The buyer's requirements are input. They may be as simple as possible for attracting large number of sellers' bid items, or as specific as needed, e.g. return on investment, e.g.

FIG. 11 Selection of Appropriate Bid Items for Forward Bidding Same interface as in FIG. 6. It shows the mean for buyer to bid by a simple click.

FIG. 12 Reverse Auction and Forward Bidding Communicate Updated Information. Real-time and synchronized listings of latest bid prices and other data.

FIG. 13 Seller's or Buyer's Request for Offer Acceptance. Similar to the Interface in FIG. 9, which serves to transmit the preferred bid price of one party to its counterpart.

FIG. 14 Finalized Reverse Auction Listing Showing All Bid Information. This shows that, by default, the two lowest-bid sellers will contact the buyer in a time unless the buyer picks other two or more sellers.

FIG. 15 Finalized Forward Bidding Listing Showing All Bid Information. This shows that, by default, the two highest-bid buyers will contact the seller in a time unless the seller picks other two or more sellers.

FIG. 16 Confirmation of Transaction, Re-Auction or Cancellation of Auction. This concludes a reverse auction and its associated forward biddings. The user has the three options.

FIG. 17 Lower than the Lowest (Higher than the Highest) Offer Acceptance. Similar to the Interface in FIG. 9, this serves to transmit the “jump the queue” bid price request and/or the item details from one party to its counterpart. The offer (bid price) is revealed at the listing and the buyer or seller has the option of inviting for direct contact, e.g. site visit.

### DETAILED DESCRIPTION OF THE INVENTION

The concept:

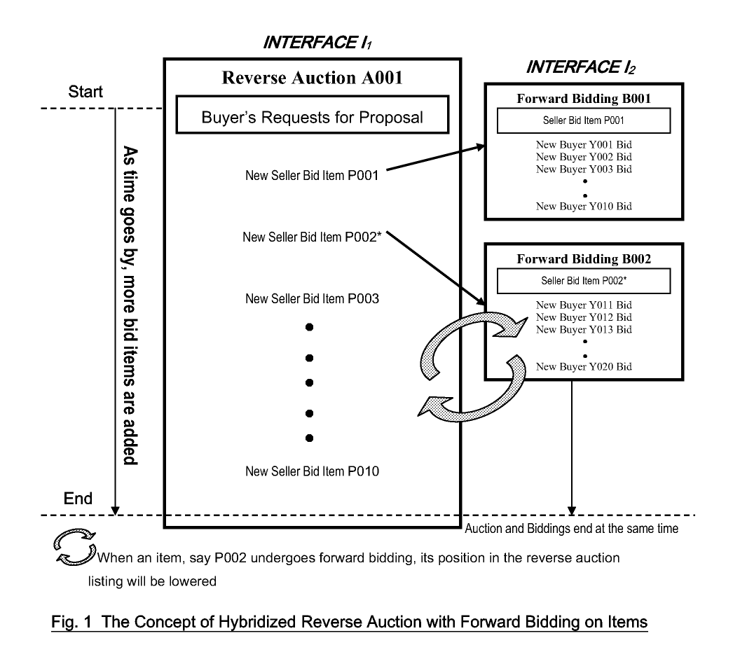

The invention revolutionizes the traditional auction methods and systems (no matter it is an online or offline execution) for real estate items, and it constitutes a new form of auction by itself. Firstly, a central website W1 hosted by a server acts as the interface for information exchange and online marketplace for transaction. The information and transaction are open to the public so that numbers of buyer and sellers are attracted. Secondly, the invention starts with a reverse auction created by a prospective buyer. The prospective buyer may come from two sources, namely registered users at W1, or users referred by another third-party website W2 which has made system integration with W1, e.g. W1 may dynamically use the premise information stored in W2's database. W2 may, by itself, be any kind of website running on, including but not limited to, any form of online auction, online shopping, online content provision, etc. Thirdly, the bid items at the reverse auction may trigger numerous forward biddings made by other buyers. This results in a reverse auction bundled with numerous forward biddings which will be executed in same period, with intercommunicating listings of new prices and new related items dynamically for updated and widest choice (FIG. 1). Fourthly, if both buyer and seller agree an item at a price before expiry of the auction or bidding, they may proceed further immediately for site investigation or entering contract, etc. Therefore, there must be meeting between buyer and seller anyhow. Fifthly, as long as the sale and purchase of the item is not yet confirmed, sellers having similar items who can offer “lower than the lowest” price concluded after the reverse auction, or buyers who can offer “higher than the highest” price concluded after a forward bidding, can “jump the queue” and request to meet the counterpart if willing to pay surcharge. All the above five steps can further increase the number of market participants and hence the competition. To conclude, this hybridized reverse auction method to be embodied for real estate items is brand new to the industry.

The system:

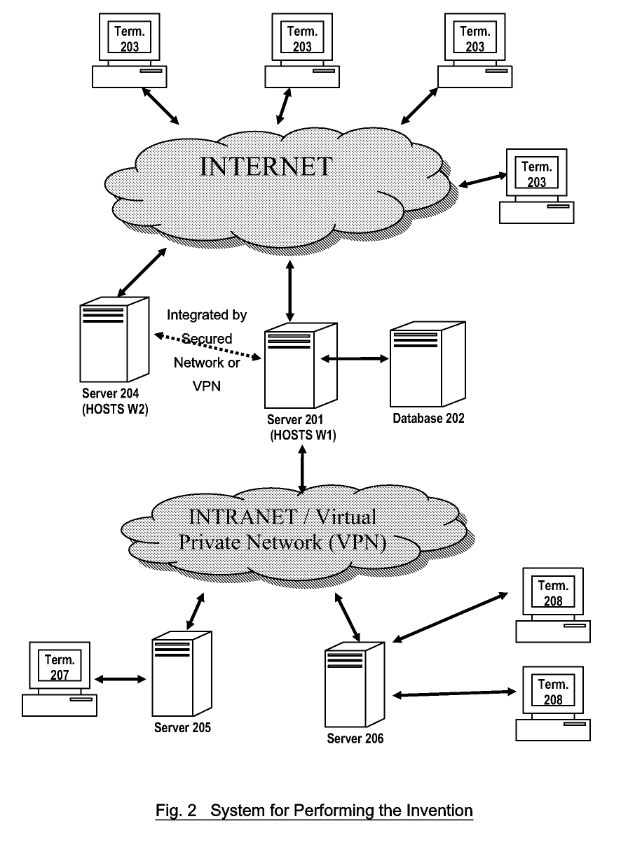

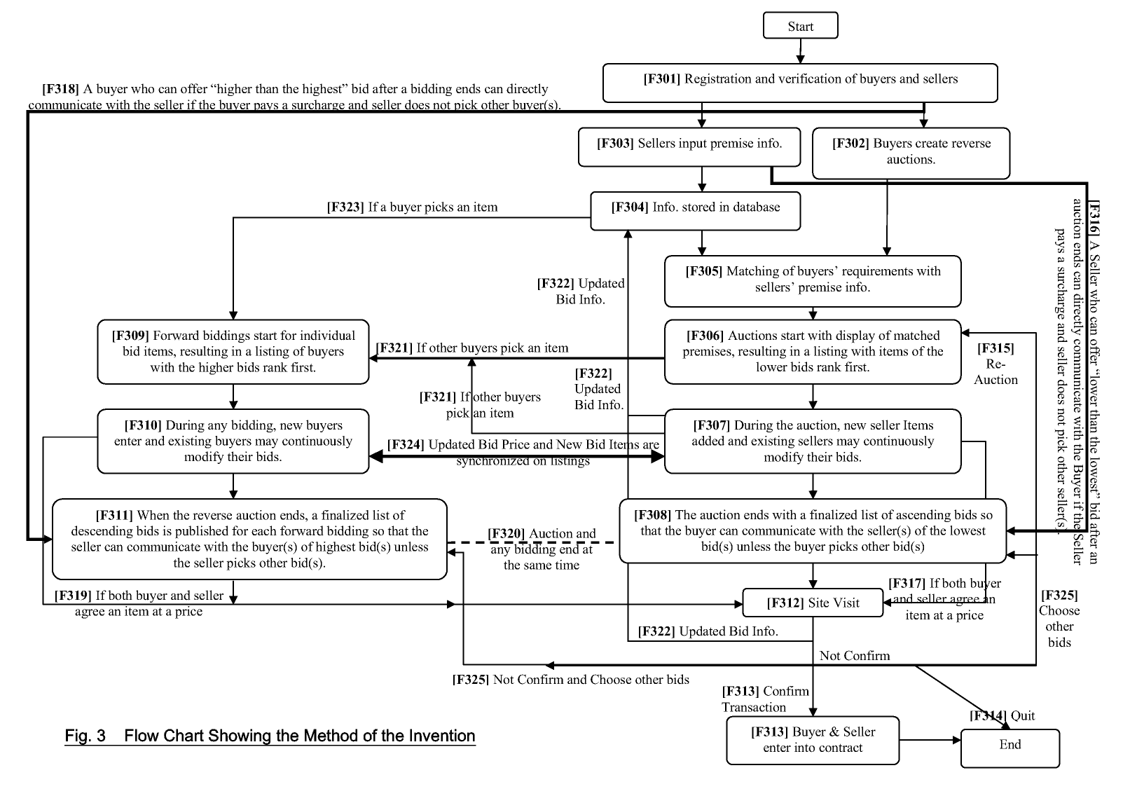

FIG. 2 is a schematic diagram showing the constitution of the system for the online reverse auction and biddings. Server 201 holds the central website W1 which is programmed to work on different modules for enabling the online auction and bidding process. (Please refer to FIG. 3 Flow Chart which details the modules and their work flow logics.) Database 202 stores premise data that registered sellers may have entered and modified from time to time. It also stores detailed information about auctions, biddings, user data and other statistics. These data and information are dynamically retrieved and stored before, during and after the auctions and biddings. Computer Terminals 203 act as the interface for general users to input and retrieve data on the one hand, and connect via the Internet to Server 201 for data interchange on the other hand. Server 204 hosting a third-party website is connected to the system if it has been integrated for supplying users and/or premise data, e.g. the third-party website may be doing online auction business. Server 205 and 206 are the private servers of some realty agent's or broker's office, which is connected to Server 201 through intranet or virtual private network (VPN) on the one hand, and Computer Terminals 207 and 208 which are for their agents' or brokers' use on the other hand.

The method:

FIG. 3 is a flow chart depicting the method of executing the invention. The buyers and sellers need pre-registration before entering into the auction [F301]. (P.S. Even in the case that the buyers and/or sellers are referred by another third-party website, their personal particulars are required and automatically “registered” in the central website W1). Such pre-registration is critical as it verifies those real buyers and sellers. In the beginning, the buyer posts his/her requirements for sellers to submit bids within the auction period [F302]. Sellers should have input their premise information beforehand [F303], which will be stored in the database [F304] for further matching with the buyer's requirements [F305]. The matching will immediately lead to an initial listing with the lower bids rank first [F306]. During the auction, sellers can adjust (probably lower) the bid prices from time-to-time. The whole bidding activities will be listed at an interface I1 [F307]. Unless both buyer and seller accept a certain bid item at a particular bid price [F317], in which the buyer and seller will probably call for site visit [F312] and undergo face-to-face negotiation, the auction continues. (P.S. seller cannot persuade the buyer to accept higher than the confirmed bid price during the face-to-face negotiation). When the auction ends, the buyer should, without obligation, pick the seller(s) of lowest bid(s) that fulfill the buyer's requirements for site visit and face-to-face negotiation on other terms [F308]. This is the reverse auction stage. Since the transaction has not yet completed during site visit and negotiation period, the auction is still open to the public for more competitive bids, i.e. other buyers willing to pay higher price for the premise [F318] or sellers willing to offer lower price for other premise of comparable quality can enter face-to-face negotiation [F316]. In other words, there may be further ascending or descending bidding succeeding to the reverse auction stage mentioned above. It is the creation of this competitive bidding environment that can maximize the reach of buyers and sellers for their suitable counterparts, expedite the transaction process and enable closest bids to the fair market value. The market is then rendered more efficient. If the major terms and conditions can be mutually agreed at the site visit, the buyer and seller will enter into contract [F313]. If the premise is found unsatisfactory after site visit, the buyer may choose other bid(s) from the finalized listings [F325], simply quit the auction [F314] or may choose to restart another reverse auction [F315] in which the premise may restart next rounds of biddings. It is to point out that information about the auction will be continuously updated to the database during the auction and after site visit because sellers and the buyer may dynamically adjust the bid price and other relevant information [F322].

During the reverse auction stage, any bids that submitted by sellers will undergo forward bidding by other buyers if there are [F321]. The forward bidding for a particular item, which is an ascending bid auction in nature, will be listed in another interface 12 [F309]. The position of the item at the reverse auction listing (interface I1) will be lower because the bid price has been increased. Any potential buyers, no matter having created reverse auction or not, can enter interface I1 or 12 and bid up the item [F323]. Again, the seller bid item may come from two sources—the data stored at W1's database [F304] or those stored at W2's database if appropriate system integration has been made between W1 and W2 beforehand. Unless both buyer and seller agree on a certain bid item at a particular price, in which case they call for site visit and make face-to-face negotiation [F319], the biddings continue until their parent reverse auction ends. During the negotiation, the seller cannot request more than the confirmed bid price. It is to point out that the reverse auction and its associated forward biddings end at the same time [F320] with one of the following three outcomes: 1) the buyer and a seller agree an item at a price during the reverse auction [F317], 2) a buyer and the seller agree an item at a price during one of the forward biddings [F319], or 3) no prior agreement can be made between buyer and seller. For 1) and 2), buyer and seller will call for site visit and negotiate. For 3) buyer should pick the lowest bid items [F308] and seller should pick the highest bid item for site visit and negotiation [F311], although these may not be always the cases. It is because the buyer, having noticed a certain seller's bid item undergoes rapidly ascending bidding, may opt to agree with the seller's bid and call for immediate site visit and negotiation. On the other hand, the seller may pick other higher bid buyers excluding the highest bid one, because the highest bid buyer may have been blacklisted by other sellers in some prior cases.

### The Embodiments

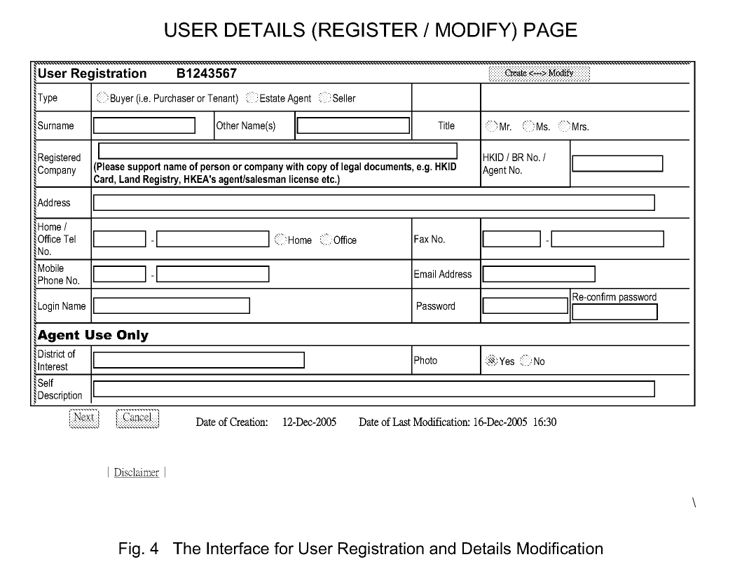

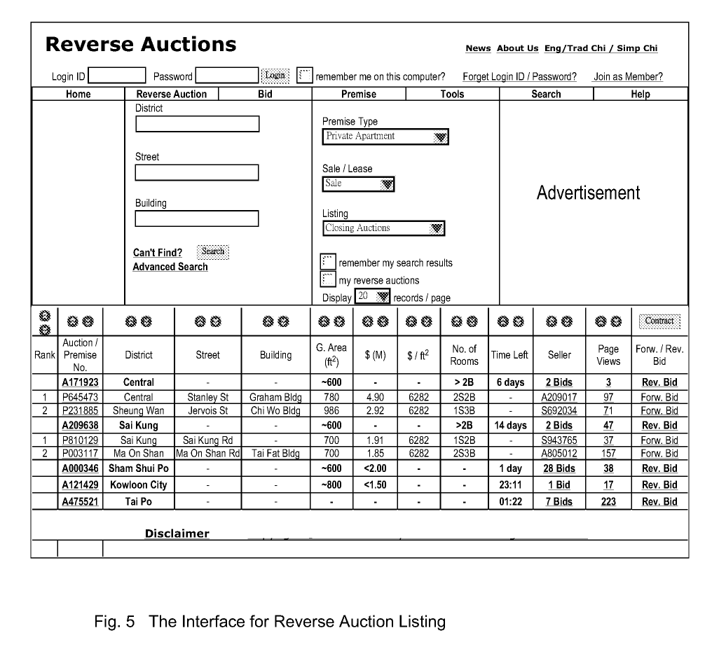

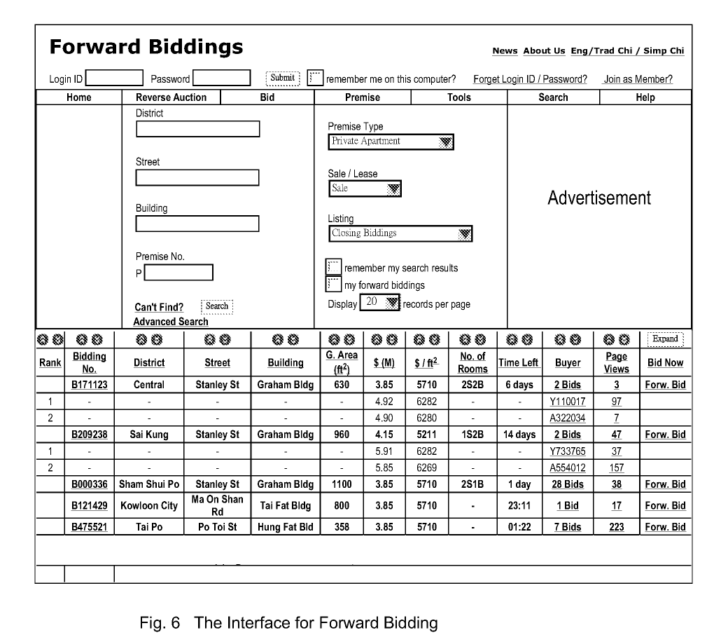

In the beginning, buyers, sellers or their proxies, i.e. agents or brokers, collectively called as “the users”, have to register. (FIG. 4). Unregistered general public can view the reverse auction listing (FIG. 5), forward bidding listing (FIG. 6), general premise details and proxy's credential, but they are not allowed to make any bid.

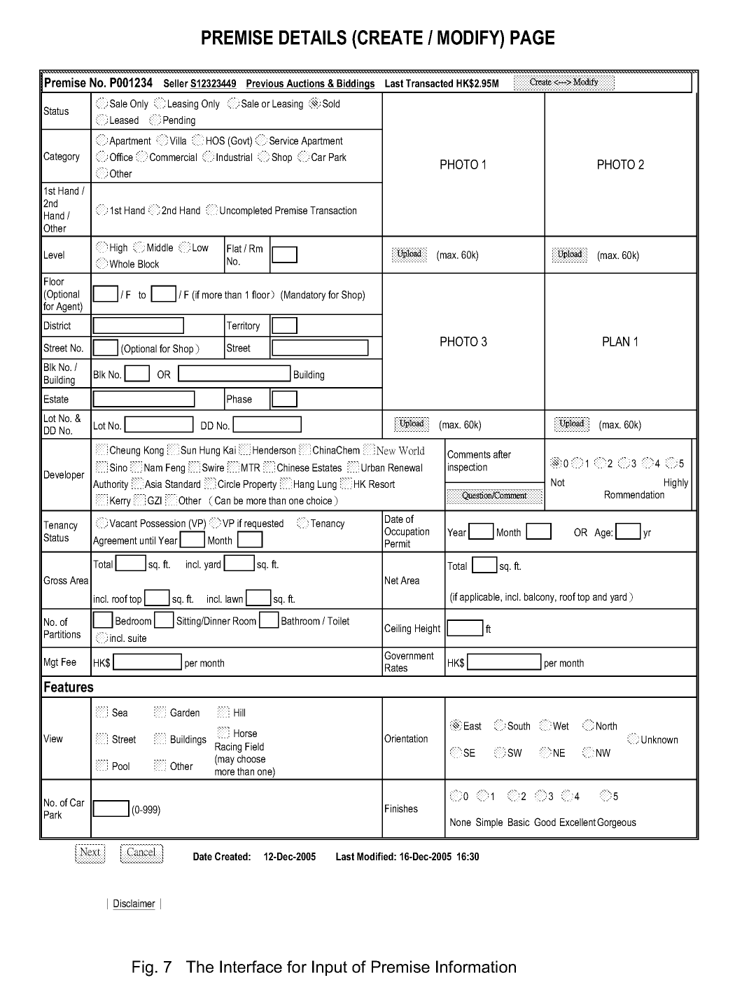

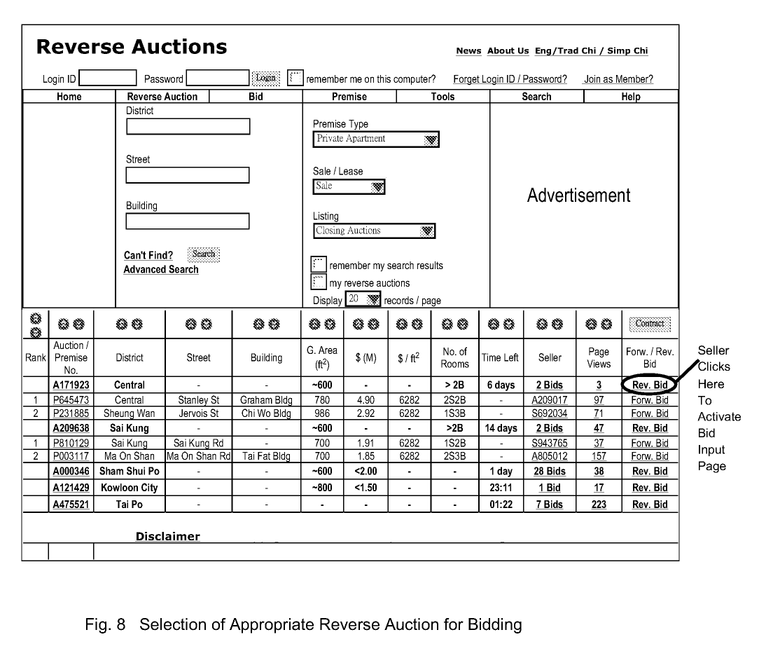

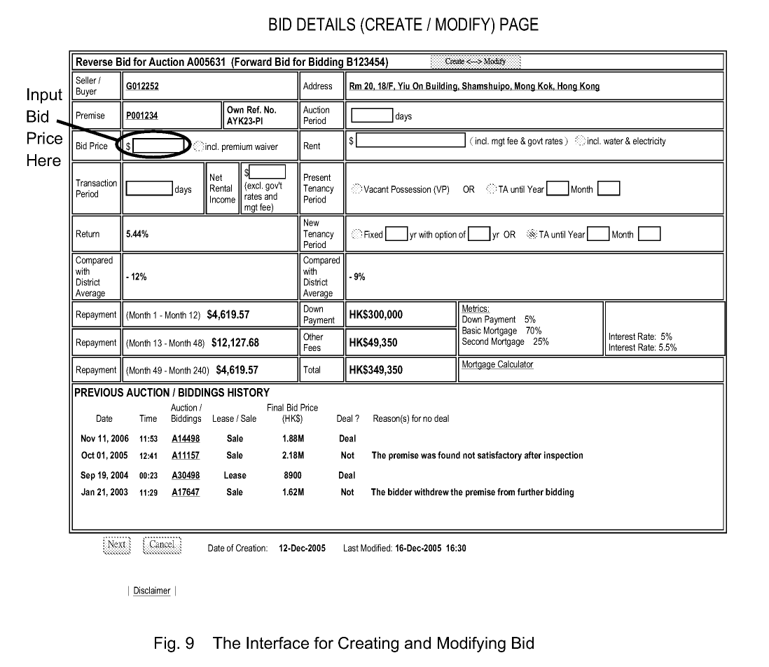

After registration, sellers have to input their premise information as detailed as possible (FIG. 7). Alternatively, they may use their stored data if they have input their information before, or use the database of a third-party website W2 which refers the seller to and has made system integration with the central website W1. Having established the premise information, they may start to pick appropriate ongoing reverse auctions (FIG. 8) and make offer (FIG. 9)

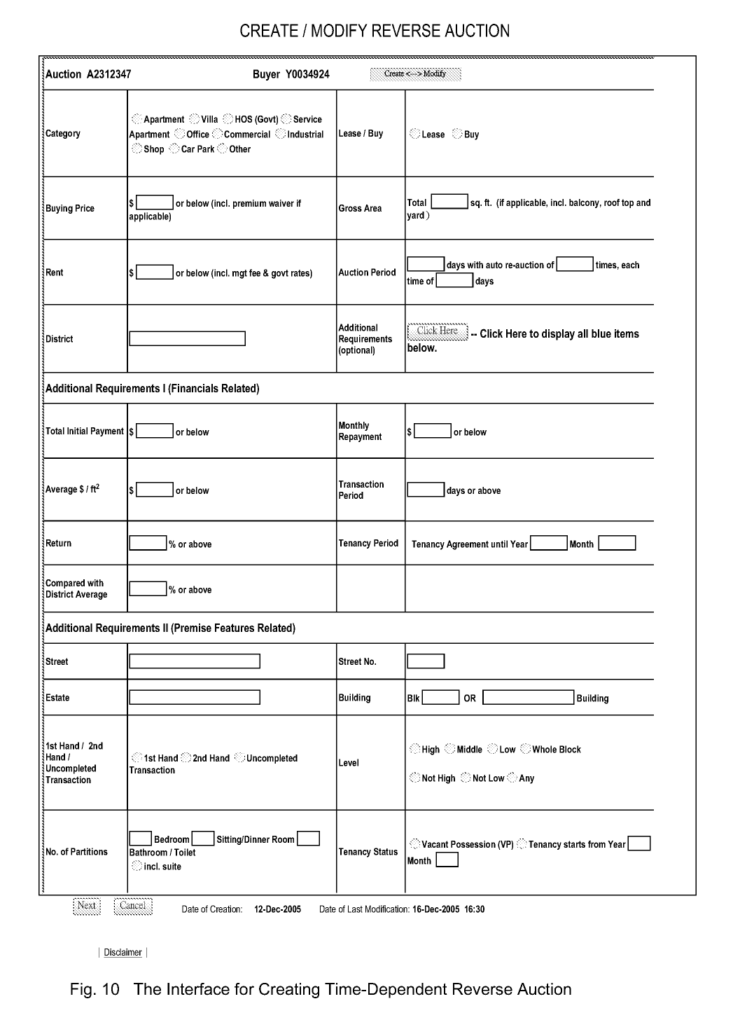

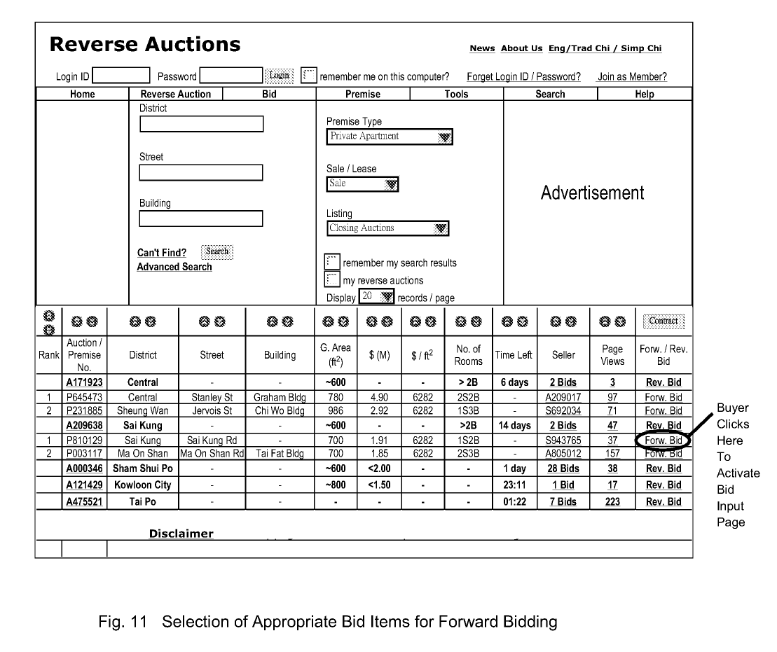

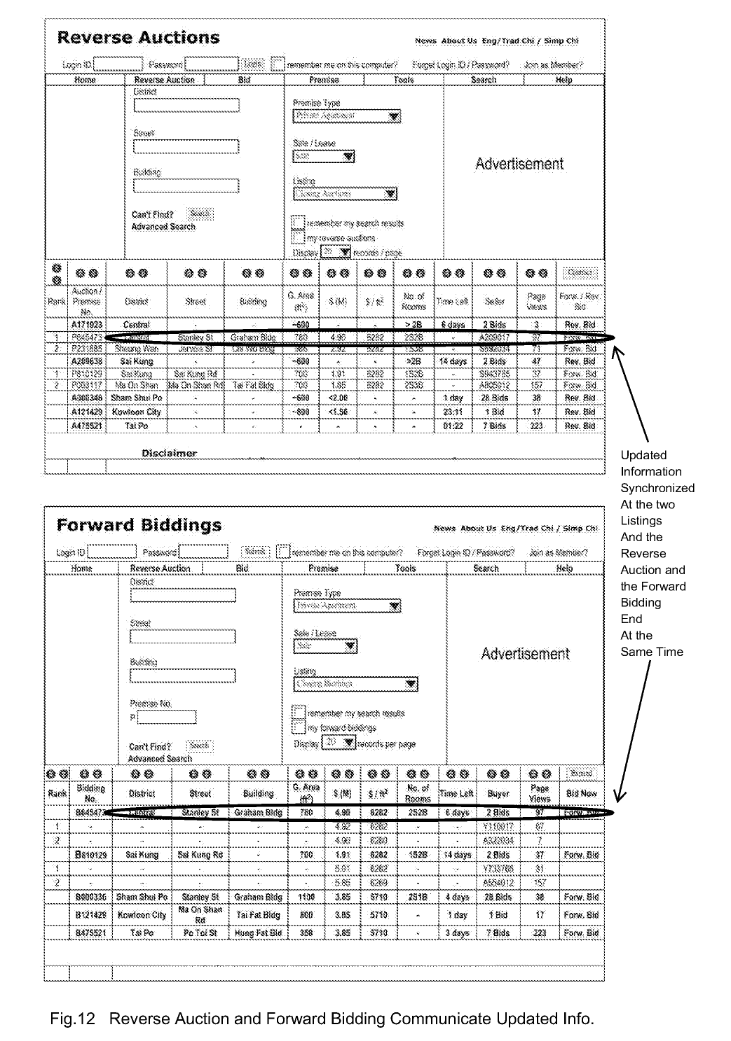

Buyers, after registration, can make purchase through two means. One the one hand, they may create a new time-dependent reverse auction to attract the seller's lowest bid item (FIG. 10). On the other hand, they may search the existing reverse auctions and make biddings to a particular bid item of a reverse auction (FIG. 11). The bidding to a particular item is an ascending bid auction in nature. The reverse auction and its associated forward biddings will communicate their updated information and they will end at the same time. (FIG. 12)

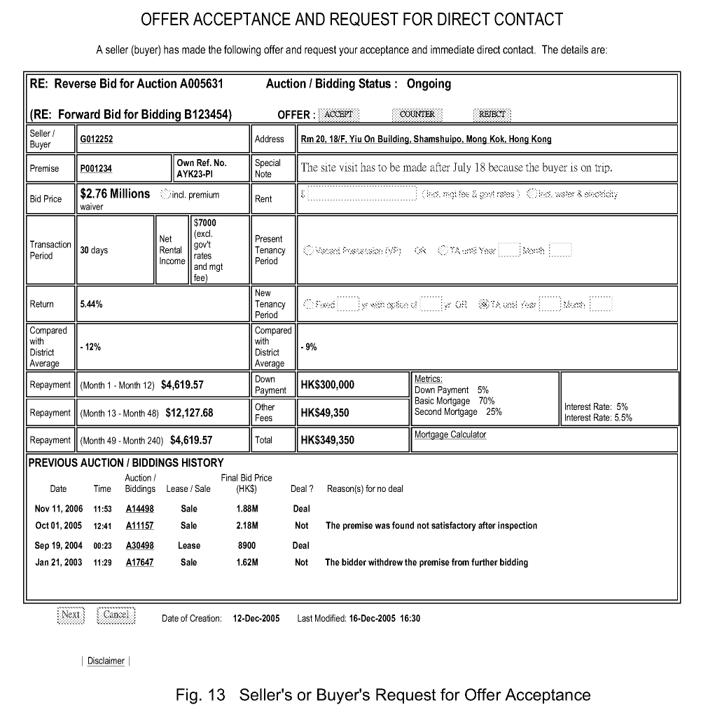

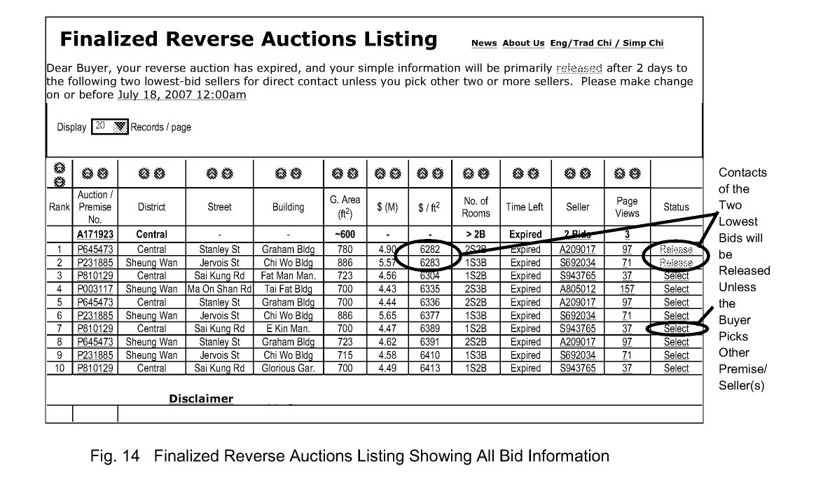

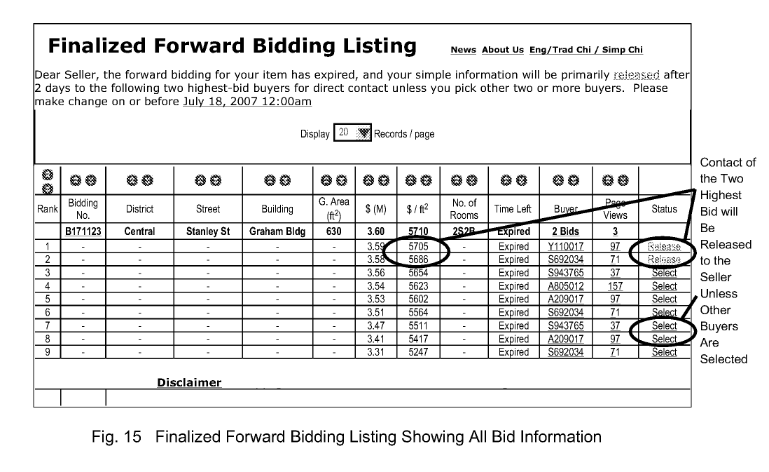

At any time during the auction, buyers or sellers may conclude the price and ask for acceptance by their counterpart (FIG. 13). Only when both buyer and seller accept an item at a price does the reverse auction and its associated biddings end. Otherwise, the auction and biddings will continue until the auction expires. When it expires and the buyer and seller does not proactively select their preferred items (not necessarily the lowest priced items), they will get their respective finalized listings in which the contacts of the first and second priority item will be released to both parties for mutual communications. The first and second priority items would be the two lowest bid items in the finalized auction listing (FIG. 14) or the highest bid buyers in the finalized forward bid listing (FIG. 15). The buyer and seller will communicate for site visit, and may come to confirmation of sales and purchase of the bid item.

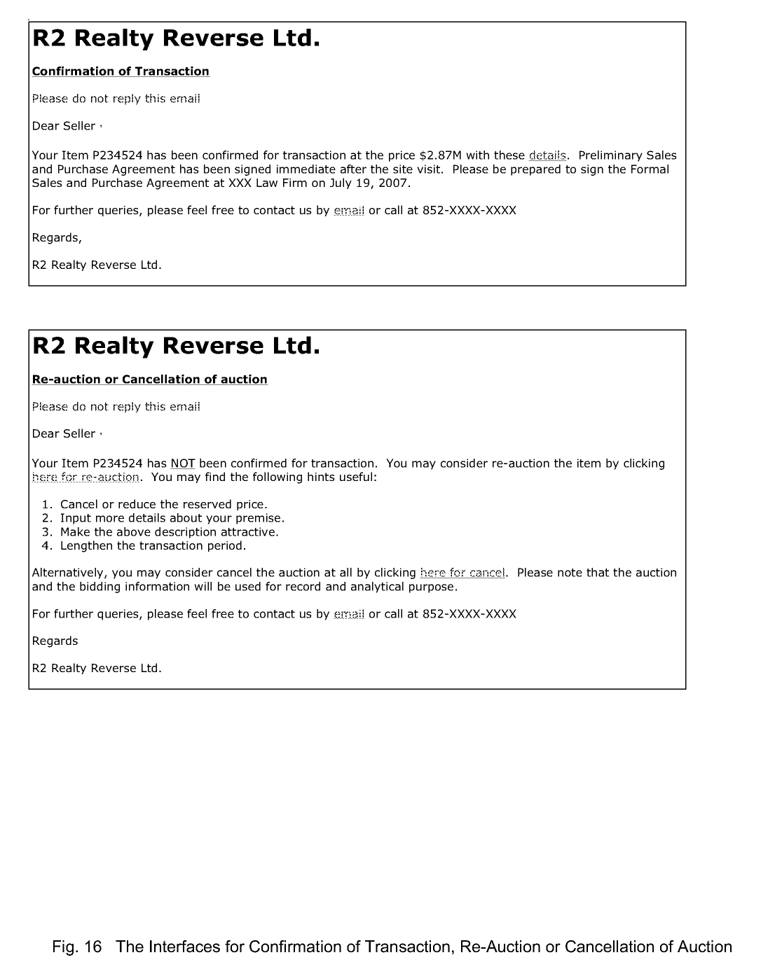

If the item cannot be concluded after site visit, the buyer and seller may opt for starting a new auction or bidding respectively, or simply choose to quit the game (FIG. 16).

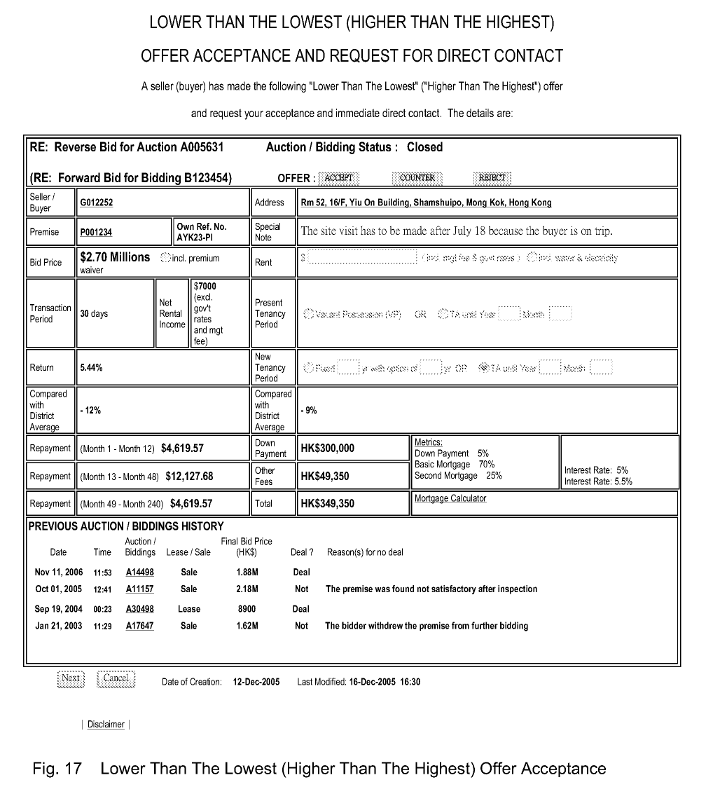

To maximize the market competition, a seller may enter an expired auction if he or she can offer a “lower than the lowest” bid and pay a surcharge (FIG. 17). Subsequently, the seller shall communicate with the buyer for site visit if the buyer wishes after consideration of the new seller's item and price. This situation is allowed until the sale and purchase of the item has been confirmed or the buyer opts to quit or restart a new auction. Similarly, a buyer may enter an expired bidding if he or she can offer a “higher than the highest” bid for a particular item and pay a surcharge.

On the other hand, early confirmation of sale and purchase of an item is possible before the respective expiry of a reverse auction or bidding. In these cases, both buyer and seller have to confirm the item at a price. This will enhance the efficiency of transaction.

1. A method implemented on a computer system for creating a reverse auction on a realty related item, wherein a buyer uses a computer-system programmed with an algorithm for creating the reverse auction and one or more sellers use a computer-system programmed with an algorithm to submit bid items, the set of procedures comprises that (1) the seller's bid item can individually undergo forward bidding by other buyers to form a forward auction on the item and (2) the series of forward biddings of one or more bid items continuously updates the bid information in the reverse auction.

2. The method of claim 1, wherein the set of procedures further comprises software programmed such that the parent reverse auction and the series of forward biddings end at the same time.

3. The method of claim 2, wherein the set of procedures further comprises software programmed such that after the auction and bidding series end, if the buyer in the reverse auction does not pick certain seller(s), the buyer and the seller(s) of the lowest bid item(s) can communicate mutually for offline investigation because their contacts are automatically released to their counterpart, and if the seller in any of the forward biddings does not pick certain buyer(s), the seller and the buyer(s) of highest bid(s) can also communicate mutually for the same above.

4. The method of claim 3, wherein the set of procedures further comprises software programmed such that after the reverse auction expires and before confirmation of the sale and purchase of the item, if a seller who can offer “lower than the lowest” bid concluded in the reverse auction, the seller can request for direct communication with the buyer if the seller pays a surcharge and the buyer does not pick other seller(s).

5. The method of claim 3, wherein the set of procedures further comprises software programmed such that after a bidding ends and before confirmation of the sale and purchase of the item, if a buyer who can offer “higher than the highest” bid concluded in the bidding, the buyer can request for direct communication with the seller if the buyer pays a surcharge and the seller does not pick other buyer(s).

6. The method of claim 1, wherein “other buyers” can or cannot include the buyer who creates the reverse auction.

7. The method of claim 1, wherein the sellers who bid at the reverse auction can or cannot set a reserve price.

8. The method of claim 1, wherein the buyer who creates the reverse auction can or cannot set a reserve price.

9. The method of claim 1, wherein the bid offer of the seller(s) can be binding, not binding, or their combinations.

10. The method of claim 1, wherein the bid offer of the buyer(s) can be binding, not binding, or their combinations.

11. The method of claim 3, wherein the software is programmed such that, after the auction and bidding end, if the buyer in the reverse auction picks certain seller(s), the buyer and the chosen seller(s) can communicate mutually because their contacts will be released to the counterpart.

12. The method of claim 3, wherein the software is programmed such that, after the auction and bidding end, if the seller in any of the forward biddings picks certain buyer(s), the seller and the chosen buyer(s) can communicate mutually because their contacts will be released to the counterpart.

13. The method of claim 3, wherein the seller(s) of the lowest bid item(s) in a reverse auction can be in a positive number as set by the system administrator.

14. The method of claim 3, wherein the buyer(s) of the highest bid item(s) in any of the forwarding biddings can be in a positive number as set by the system administrator.

15. The method of claim 1, wherein the reverse auction may function as a standalone system, or as an integrated module to any system, which may refer buyers and/or sellers to this system and supply part or all of its data required for the reverse auction.

16. The method of claim 1, wherein buyer comprises one or more of the following persons: (i) the one who wants to buy and own the premise, (ii) the one who wants to rent the premise, or (iii) the proxy that either (i) or (ii) shall use, e.g. agent or broker.

17. The method of claim 1, wherein seller comprises one or more of the following persons: (i) the one who wants to sell or least out the premise, (ii) the proxy that (i) shall use, e.g. agent or broker.

18. The method of claim 1, wherein item comprises one or both of (i) the premise itself or (ii) the leasing of the premise.

19. The method of claim 1, wherein the reverse auction comprises software programmed to interweave one or more forward auctions.

20. A computer-based system for conducting a reverse auction on a realty related item, the system comprising a computer have software programmed with instruction that permit a buyer to create the reverse auction and one or more sellers to submit bid items, wherein the software is programmed such that (1) the seller's bid item can individually undergo forward bidding by other buyers to form a forward auction on the item and (2) the series of forward biddings of one or more bid items continuously updates the bid information in the reverse auction.
